(19) United States
(12) Patent Application Publication
(10) Pub. No.: US 2005/0220595 A1
(43) Pub. Date: Oct. 6, 2005

(54) Convertible dovetail trailer

(76) Inventor: Curtis Hull, Clarinda, IA (US)

Correspondence Address: Wm Bruce Day;DAY LAW FIRM, P.C., 4330 Belleview, Suite 300, Kansas City, MI, 64111-3579, US

(21) Appl. No.: 10/818,062

(22) Filed: Apr. 5, 2004

(51) Int. Cl. B60P 1/00

(52) U.S. Cl. 414/537

(57) ABSTRACT

A trailer has a tail end which is convertible from a sloping ramp for ease of loading to a level load carrying surface. The trailer has a forward, level deck with a fixed, sloping tail end ramp frame. A platform structure mounted on the ramp frame has a forward end hingedly connected at a rear of the level deck. A raising mechanism extends between the tail end of the ramp frame and the platform for swinging the platform upwardly to level with the deck to form an extension of the deck. Two embodiments of the trailer are disclosed. The second embodiment has a center section raisable platform with fold out ramps on either side of the platform which swings out to ground surface. The center section can be raised and the fold out ramp swung inwardly to create a level load surface level with the trailer deck. The first embodiment has a raisable platform structure which extends across the entirety of the tail end ramp frame. Loading ramps extend from pull out storage pockets to enable loading on the retracted platform structure and then to the level deck. After loading, the platform is raised and the load on the trailer can be moved to any position on the trailer.

### FIELD OF THE INVENTION

This invention relates to trailers with tail end ramps and particularly to such trailers in which the tail ramp can be raised to a level deck surface for added carrying capacity or load distribution.

### BACKGROUND OF THE INVENTION

Convertible ramp trailers, sometimes called dovetail trailers, are useful for carrying extended loads because the tail end structure can be raised from a downwardly tilted position, which enables ease of loading, to an upper position level with the trailer deck for carrying the load on the rear portion of the trailer. Some trailers have sloping rear tail sections, but this area is generally unusable to carry loads. Others trailers, such as shown in U.S. Pat. No. 6,186,734, have a sloping tail end surface with a fold-out ramp which engages the ground, and enables a vehicle to be driven upwardly and on the trailer deck. While the use of fold-out ramps and sloping tail ends for loading a wheeled vehicle is common, far less common are those trailers in which a tilted ramp can be raised to a flat position. U.S. Pat. No. 6,394,734 is one the few that discloses repositioning of a downwardly inclined tail section upward to a level transport position. The '734 patent discloses a bulky, cumbersome and expensive tail assembly in which the whole of the assembly is hingedly connected to the trailer main deck and swings up or down upon actuation of hydraulic lift mechanisms.

### OBJECTS OF THE INVENTION

The principal objects of the invention are: to provide a trailer having a tail end which is convertible from a sloping loading ramp to a level load surface; to provide such a trailer which enables carrying an object on the load ramp in a level position; to provide such a trailer which is inexpensive to produce and is low or no maintenance; and to provide such a trailer which is well adapted for its intended purpose.

### SUMMARY OF THE INVENTION

A trailer has a deck terminating in a sloping dovetail end for loading. The dovetail end has an underlying fixed supporting frame structure and a platform structure on the supporting frame. The platform structure is hingedly mounted so as to lower against the supporting frame and to raise to a level position which is an extension of the trailer deck. The invention is provided in two embodiments. In a first embodiment, the platform extends across the entire ramp frame and is movable between a lowered position on the ramp frame, which facilitates loading, and a raised position providing a level surface, coincident with the trailer deck for carrying the object. Separate ramps are carried by the trailer in the second embodiment which are deployed to span the gap between the ground surface and the termination of the platform when in the lowered position. These ramps can be carried in pockets longitudinally under the trailer ramp frame. In the second embodiment, the platform is a center section bounded by left and right side ramps which are hingedly connected and fold outwardly from the ramp frame to provide extensions. When the center section platform is lowered to its full down position, a vehicle can be wheeled, winched or driven up the ramps without interference from the lowered center section. Thereafter, the left and right side ramps can be swung back to the folded position and the center section raised on the support frame so as to provide a level surface for carrying the article.

### BRIEF DESCRIPTION OF THE DRAWINGS

FIG. 1 is a perspective view of the end of a trailer and showing a first embodiment of the dovetail trailer ramp end.

FIG. 2 is an enlarged fragmentary side view of a foldable support leg used with the dovetail end when loading.

FIG. 3 is an enlarged fragmentary view showing a raising mechanism.

FIG. 4 is an enlarged fragmentary view showing the raising mechanism in a lowered position.

FIG. 5 is a rear elevational view showing the dovetail trailer loading end in an upwardly raised level position.

FIG. 6 is an elevational view showing the dovetail trailer end in a lowered inclined position.

FIG. 7 is a perspective view of a second embodiment of the dovetail trailer.

FIG. 8 is an end elevational view of the second embodiment of the dovetail trailer.

FIG. 9 is an enlarged fragmentary view showing a raising linkage mechanism for the second embodiment of the dovetail trailer end.

FIG. 10 is a fragmentary view showing the raising linkage mechanism.

### DESCRIPTION OF THE PREFERRED AND ALTERNATE EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

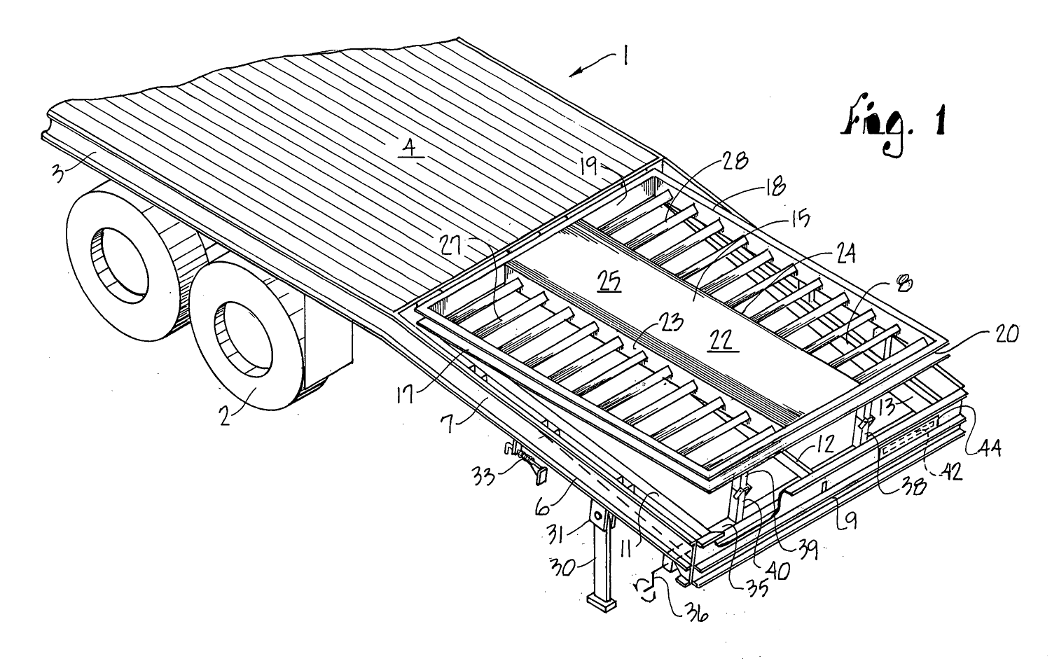

The reference 1, FIG. 1, generally indicates a dovetail end trailer, a portion of which is shown in the drawings. The full trailer has a front end with a towing hitch, typically a fifth wheel hitch or a frame hitch, for a drafting by a tow vehicle, typically a pickup truck. The trailer has ground engaging wheels 2, such as the dual axle wheels shown, opposite structural side rails 3 and a deck 4 which is flat and unencumbered for carrying a load. Typically, these trailers are used for hauling wheeled vehicles, such as cars, trucks, agricultural tractors, forklifts, skid steer tractors and the like. They are purchased by old car enthusiasts, contractors, farmers, nurserymen, and landscapers to haul their equipment. The dovetail trailer 1 of the present invention, in which the rear or dovetail loading end is raisable to a position generally level with the deck 4, finds particular use when the user must haul more than one car, tractor, loader, etc., on the trailer. In hauling loads on a trailer, the load must be properly balanced. Too far forward and too much weight is placed on the draw tongue, forcing the rear of the tow vehicle down and the front end up, and resulting in an unstable load. Too far back, the trailer draw tongue tends to pull upwardly, pulling up on the rear end of the tow vehicle and down the tow vehicle front end, also resulting in an unstable load condition. Ideally, the weight on the trailer is placed on or just forward of the trailer wheels 2, resulting in a balanced load for safe towing. When loading multiple vehicles on the dovetail trailer, the first vehicle is driven full forward on the trailer, which usually results in an excessive weight forward position. The second vehicle is driven forward as much as possible, the dovetail end raised, and all vehicles moved rearwardly, including on the raised dovetail end, to balance the load. If not for the dovetail end being raisable to a level position, a trailer could be restricted to less than its full carrying capacity and a hauler could load and haul only one vehicle on the trailer.

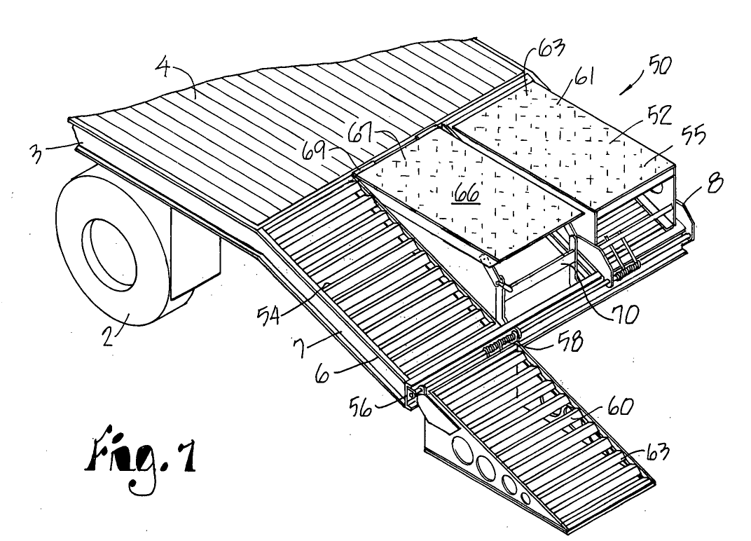

One embodiment of the dovetail trailer is shown in FIG. 1 wherein the whole dovetail end platform raises up from an inclined loading position to a level load carrying position. The second embodiment is shown in FIG. 7 wherein opposite side ramps fold out to the ground surface. A center section provides a platform which raises and lowers for loading and for carrying purposes. When the ramps are folded back onto the dovetail end, they form a level surface continuous with the raisable center section so that a vehicle driven onto the dovetail trailer 1 can be backed and supported on the dovetail end. Neither embodiment is preferred over the other. Applicant constructs and sells both versions and customers buy according to their likes.

In the whole platform embodiment shown in FIG. 1, a sloping tail end ramp frame 6 is fixed in angle and extends from the deck portion of the trailer 1. The angle of extension is approximately eleven (11) degrees, and the ramp frame extends rearwardly of the deck 4 approximately five (5) feet. The frame 6 consists of spaced side rails 7 and 8, an end rail 9 and additional side and longitudinal rails 11, 12 and 13 positioned respectively against the sides and in the center between the side rails 7 and 8 and connected at end terminations to the end rail 9. The rails 11, 12 and 13 are situated below the upper level of the side rails 7 and 8 such that a dovetail platform 15 nests between the side rails 8 and 9 when fully lowered.

The dovetail platform 15 consists of a generally rectangular frame of side rails 17 and 18 and forward and rear end rails 19 and 20. The rails 17-20 are generally channel beams. A deck top center section 22 is longitudinally mounted and connected between the end rails 19 and 20. The deck top center section has opposite side rails 23 and 24 and a plate top 25, preferably with a non-skid pattern. Drive ramps 27 and 28 are on either side of the center section 22 and are formed of short lengths of angle beams with the angle upwardly so as to provide good traction for a vehicle being driven upwardly on the dovetail platform 15. Support legs 30 extend downwardly from hinged mounts 31 positioned on the bottom of the side rails 7 and 8 and spaced a short distance forwardly of the end rail 9. These support legs 30 prevent the trailer 1 from tilting upwardly as heavy vehicles are driven onto the ramp 6. The support legs 30 are stowed by folding forwardly and secured by a latch 33.

To raise and lower the dovetail platform 15 relative to the ramp frame 6, a raising structure extends between the tail end ramp frames 6 and the platform 15 to swing the platform structure upwardly to form a level extension of the trailer deck 4. In the illustrated example, FIG. 1, the structure includes a rotatable bar 35 rotatable by a side lever 36. A toggle arrangement 38 includes upper and lower lengths 39 and 40 that hingedly connected and are angled so that when the lengths 39 and 40 are aligned, the toggle arrangement 38 provides an over-center position so that the dovetail platform 15 will not collapse upon a load being placed thereon.

When the dovetail platform 15 is in the fully lowered position, there is still a lip extending above a ground surface such that short ramps are necessary for a vehicle to drive on to reach the edge of the dovetail platform 15. These ramps 42 are contained in pockets 44 through the end rail 9. The ramps 42 have hook ends that fit over the rear end rail 20 of the dovetail platform 15.

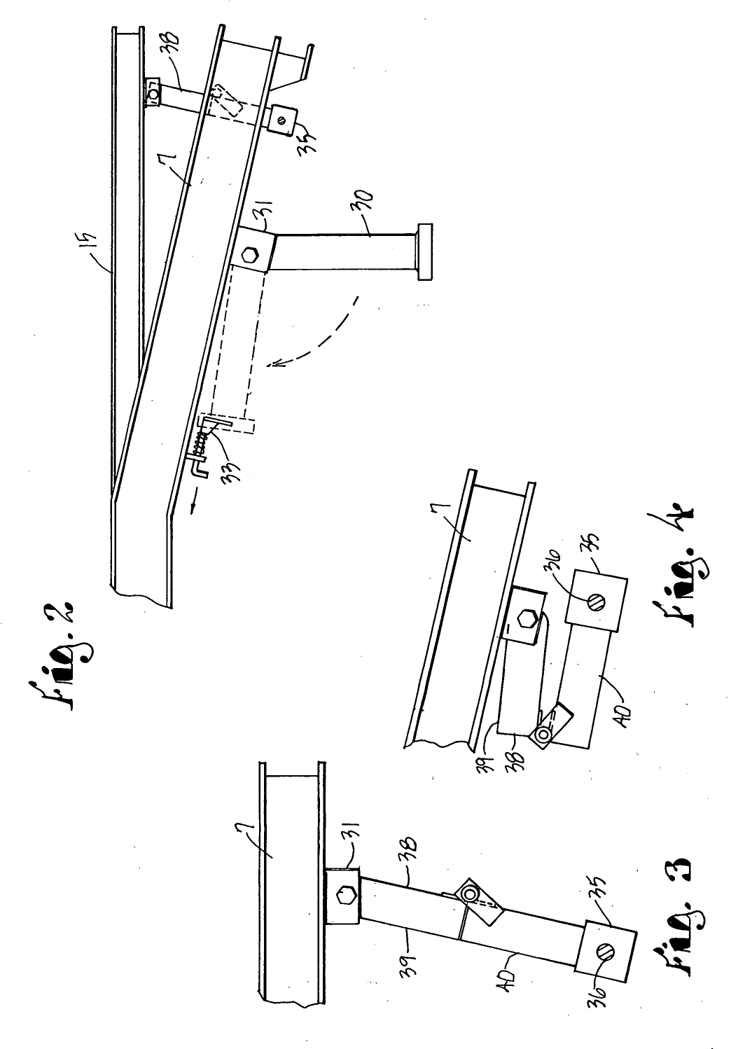

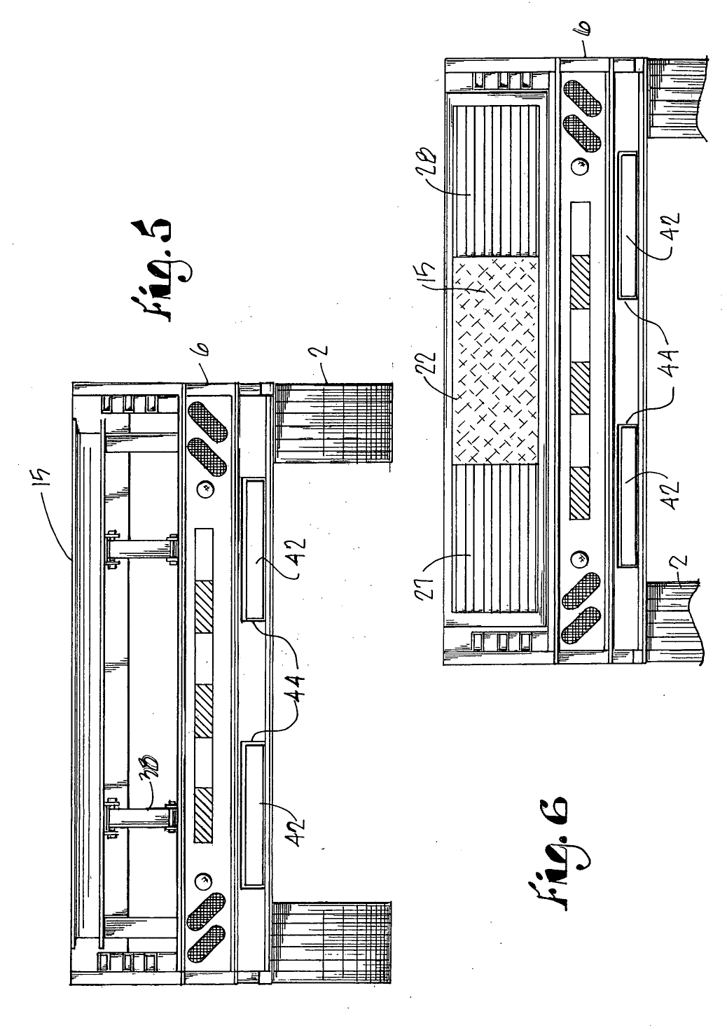

An alternative form of a dovetail trailer 50 is shown in connection with FIGS. 7 through 10. In the alternative embodiment 50, instead of the whole dovetail platform 15 raising and lowering as it does in the FIGS. 1 through 6 embodiment, there is a three-section dovetail platform 52 divided into spaced left and right side ramps 54 and 55. The side ramps 54 and 55 are fold-over types which swing about a hinge 56 having an assist spring 58. Each side ramp 54 and 55 are the same with each having ramp surfaces formed of angle beam crossbars 60 for traction while driving upwardly on the ramp. When the ramp is folded out, as is the left ramp in FIG. 7, the ramp provides a smooth drive-on surface all the way from ground level to the trailer deck 4. When the ramp is folded or stowed, as is the right ramp 55 in FIG. 7, the bottom surface 61 of the ramp extension 63 has a steel plate surface to enable a vehicle to be first driven on the deck 4 then backed up so that its wheels rest on the surface 61 of the side ramps 54 and 55.

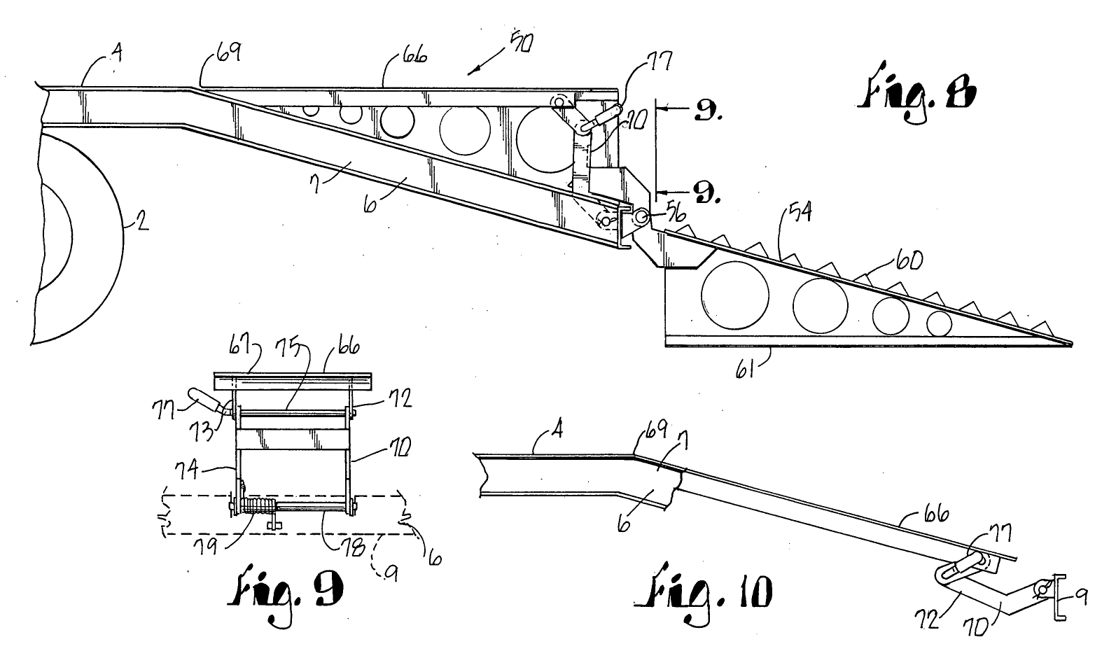

The alternative embodiment 51 includes a center section 66 which forms a dovetail end platform which moves up and down relative to the ramp frame 6. The center section 66 is simply a platform 67 hinged 69 at a front end and with the rear end swingable up and down relative to the underlying ramp frame 6. Structure 70 such as a toggle arrangement 72 enables the center section 66 to raise up and down with upper and lower link arms 73 and 74 and a center hinge pin 75 rotated by a level arm 77. The center hinge pin 75 is arranged so it is secured one of the link arms 73 or 74 with the other freely revolving so that when the lever arm 77 is thrown, the toggle arrangement 72 rotates into an over-center position FIG. 8 to extend the center section platform 67 to a raised position. When the lever arm 77 is thrown the other direction, the center section 76 lowers to the loading position shown in FIG. 10.

The center section 66 has at the lower position for the toggle arrangement 72 a hinge bar 78 with spring assist 79 toward the raised position.

The alternative embodiment 50 acts substantially the same as the first embodiment wherein when raised, the center section 66 and the side ramps 54 and 55, when swung forwardly, combine to create a level extension of the trailer deck 4 so that a vehicle may be loaded on the trailer and then positioned rearwardly for the most effective balance and control of the trailer.

The forms of the invention described above are to be used as illustration only and should not be utilized in a limiting sense in interpreting the scope of the present invention. Obvious modifications to the exemplary embodiments, as herein above set forth, could be readily made by those skilled in the art without departing from the spirit of the present invention.

The inventors hereby state their intent to rely on the doctrine of equivalence to determine and access the reasonably fair scope of the present invention as pertains to any apparatus not materially departing from but outside the literal scope of the invention as set forth in the following claims.

1. A trailer having a tail end convertible from a sloping ramp for ease of loading to a level load carrying surface, the trailer comprising:
a) a forward, level deck and a fixed sloping tail end ramp frame;
b) a platform structure having a forward end hingedly connected at a rear said deck; and
c) structure extending between said tall end ramp frame and said platform structure for swinging said platform structure upwardly to level with said deck to form a level extension thereof.

2. The trailer set forth in claim 1 wherein said structure includes a rotatable bar having a toggle arrangement for lifting said platform structure.

3. The trailer set forth in claim 1 wherein said platform structure extends across the entirety of said tail end ramp frame.

4. The trailer set forth in claim 1 wherein said platform structure is a mid 17 segment of said tail end ramp frame.

5. A trailer having a deck terminating in a sloping dovetail end and comprising:
a) the deck being a forward, level deck;
b) the dovetail end sloping down from a rear end of the deck for loading purposes;
c) the dovetail end having a fixed supporting frame and a platform structure hingedly mounted so as to lower against said supporting frame and to raise to a level position providing an extension of said level deck.

6. The trailer in claim 5 including a mechanism for raising and lowering said dovetail end relative to said fixed supporting frame.

7. A trailer having a tail end which is convertible between a sloping ramp for ease of loading and a level surface for carrying articles thereon, the trailer comprising:
a) a forward, level deck terminating in a sloping tail end ramp frame;
b) spaced left and right side ramps hingedly connected and foldable outwardly from said ramp frame to provide extensions thereof for ease of loading objects on the trailer, the side ramps, when folded atop the ramp frame providing a level surface suitable for carrying objects thereon;
c) a center section on the ramp frame movable between a down position on said ramp frame permitting an object spanning between said side ramps to be loaded without interference, and an up position providing a level surface coincident with the side ramps and the deck for carrying the object; and
d) mechanism extending between side ramp frame and said center section for raising and lowering said center section.

8. A trailer having a tail end which is convertible between a sloping ramp for ease of loading and a level surface for carrying articles thereon, the trailer comprising:
a) a forward, level deck terminating I a sloping tail end ramp frame;
b) a platform extending across said ramp frame and movable between a lowered position on said ramp frame facilitating loading on object on said trailer and a raised position providing a level surface coincident with the deck for carrying the object; and
c) mechanism extending between said ramp and said platform for raising and lowering said platform.
